(19) United States
(12) Patent Application Publication
(10) Pub. No.: US 2016/0217514 A1
(43) Pub. Date: Jul. 28, 2016

(54) ELECTRONIC MEDIA REVERSE BIDDING SYSTEM AND METHOD

(71) Applicants: Robert Franklin Greer, Westfield, IN (US); Brian Scott Hockett, Indianapolis, IN (US); Michael Alan Beer, Westfield, IN (US)

(72) Inventors: Robert Franklin Greer, Westfield, IN (US); Brian Scott Hockett, Indianapolis, IN (US); Michael Alan Beer, Westfield, IN (US)

(21) Appl. No.: 15/009,690

(22) Filed: Jan. 28, 2016

Related U.S. Application Data
(60) Provisional application No. 62/109,036, filed on Jan. 28, 2015.

(51) Int. Cl. G06Q 30/06

(52) U.S. Cl. CPC G06Q 30/0611

(57) ABSTRACT

An electronic media trading or dealing system, when customer provides specifics of the desired item and traders are involved in a reverse bidding striving to entice the customer to purchase their product is disclosed. Traders are denied the knowledge of the customer's identity until their bid is selected. The customer is not involved in any direct communications with traders, until the desired price is negotiated and the offer is accepted. This system and method saves the customer hours of browsing through countless websites in search of the desired merchandise. Additionally, the described system and method promote integrity among traders. As a result, customers win by attaining a much better deal on the product through a much lesser hassle often associated with any direct purchase, and traders are provided with a much better tool to reach potential customers without the use of a large sales force.

This application is based on and claims benefit to U.S. provisional application 62/109,036 filed on Jan. 28, 2015.

### BACKGROUND OF THE INVENTION

The present system and method relates to electronic media technologies for a merchandise trade, and more specifically to electronic media trading or dealing systems and methods.

Electronic media is defined as media that uses electronics or electromechanical energy for the end-user (audience) to access the content. Electronic media differs from a static media (usually print media). Modern day static media is often created electronically, but electronics are not required for the end-user to reach its content in the printed form. The main electronic media sources familiar to the general public are online content, video recordings, audio recordings, multimedia presentations, slide presentations, CD-ROM, and online content. Most new electronic media are in the form of digital media. Digital media are any media that are encoded in a machine-readable format. New electronic media usually refers to websites, video games, and social media, where content is available on-demand through the Internet, accessible on any digital device, usually containing interactive user feedback and creative participation. Electronic media may be in either analogue electronics data or digital electronic data format. Any equipment used in the electronic communication process (e.g. desktop computer, laptop, handheld device, telephone, television, radio, game console, etc.) may also be considered electronic media.

In a world of merchandise trade (also referred as “shopping”) in electronic media, customers are often faced with the undesirable and time consuming browsing through countless offers published by a myriad of suppliers (also referred as “merchants”, “dealers”, “suppliers”, “vendors”, or “sellers”). Quest for the product usually begins with the entry of the description of the desired item. After the search engine displays thousands of results, customer proceeds to flip through suggested images, in search of the preferred appearance. When the appearance is narrowed down, customer attempts to locate the best price for the selected item. Valuable customer's time is often wasted searching for the desirable item, and the price of the final selection may be far from the best available price on the market.

Another issue with the electronic media shopping lies in general structure of the search browsers. The search for a merchandise usually places the largest suppliers on the front pages of the search result. Suppliers may advance in the search engines hierarchy by either making payment to the search engine management or by slowly gaining popularity among the browsing customers. Consequently, some new or not well-funded suppliers' websites are usually displayed only at the bottom of the list, or at the back pages of the search results. Customers are unlikely to visit the low-ranking suppliers' websites that were placed at the bottom or on back pages of the search results, even if their merchandise is superior in quality and price.

After the desired product is located, the customer usually deals with additional problems associated with finalizing the sale. In the auto industry, for instance, locating the car online is usually followed by the unavoidable direct contact with the dealership. Most of the car buyers have to proceed through the bothersome negotiation process with the dealership floor salesman, often discovering that the published price and vehicle specification are no longer available or changed due to some perplexing technical reasons.

Some dealerships post their cars directly on their websites, attaching all technical specifications, vehicle description and price to a good quality image. Using such sales method requires extensive search by a customer, leading often to finding only a partial match to the desired vehicle. Such method involves one customer and one dealer interacting through the dealer's website. The customer is not allowed an opportunity to receive competing bids from other dealers, being stuck with the presented stock and pricing. Searching for a better deal relies fully on the customers' ability and desire to browse through the competitors' offerings. The competitor dealership is not made aware of the fact that customer has visited someone else, resulting in little incentive for every dealer to decrease the price of their product.

Similar to customers, merchants have to extend unprecedented effort and assets to advertise their product online, hoping it would get noticed by the browsing buyer. Due to the internet's continuously growing complexity and always developing new technologies, merchants have to constantly update their databases, quality of images, display of product specifications and prices. Expensive marketing efforts decrease profit margins, raising the need for a better and more efficient way to deliver products to customers.

There are known systems allowing customers to access multiple dealers in one online source. For example, multiple car dealers and their inventories are placed on centralized servers, where customer may enter the description of the desired vehicle through a user-friendly interface. Such system provides customer with the stock availability in the nearby dealerships, based on the customer's zip code or GPS location. The system usually directs customer to contact one of the selected dealerships, checking on the vehicle availability and entering into a stressful negotiation with a sales person. There is no simultaneous bidding from competing dealerships associated with any of the existing car sales methods.

The hotel searching industry utilizes electronic media systems, when customers may enter the desired location and the lowest bid for the desired room. The system then searches the hotel availability through its database, sometimes even contacting hotels in the area, in search for a price match. The shortcoming of this system is that the price is locked by the customer, often resulting in zero findings, low availability, or unpredictable quality of the hotel. The bidding is also blind, or partially blind, meaning that the customer does not have control over the details of the searched item, often being stuck with a low quality merchandise at the end of the transaction.

Some systems, like eBay, allow the trader to place merchandise online, inviting purchasers to place their bids. Purchasers are made aware of the increasing price. The system is designed to steadily increase the price, being favorable to the seller and not the purchaser. Additionally, the eBay model is not designed to pull all available sellers into one pool, allowing one product per transaction only.

Until now, there was no system or method that would allow the customer to simply describe the desired product, leading to all available market traders to bid on the customer's order, resulting in customer receiving the best deal in terms of the desired specification and price. Having such method would allow the customer to bypass frustrating face-to-face meetings with sales agents. It would also guarantee the best price available on the market without entering into a price-tag war with the trader. Such method would keep traders' integrity at the highest level, denying them the opportunity to include “hidden” costs in their merchandise. Such method would also perform a role of a “middle-man”, taking care of the negotiation and bidding process, allowing customers to receive the best match for the desired product at the best price the market may offer. Such system may only function in the electronic media, requiring an electronic device and software to perform multitudes of operations in order to assist the placement of a very specific order, followed by a complicated search through either the local server or through outside servers, leading to managing logistics of communications during the bidding process, and concluding with the final facilitation of the sale confirmation.

There is an unmet need for an electronic media system and method that will address all of those issues, providing a simple way for a customer to enter the exact description of the desired item followed by a hassle-free short wait for the system to deliver several exact or very close matches, at a best price range, ready to either be picked up or delivered directly to the customer. Such system and method will allow bypassing all problems with the currently available technology and avoiding all user-related issues.

### SUMMARY

Accordingly, the current invention provides a new electronic media trading system and method (referred also as “electronic system and method”, “system and method” or “system”) to place an order for merchandise by entering the detailed product description, followed by transferring the order to all available traders, and involving traders in a bidding process, when they will be made aware only about the competitors' products and prices, while not having an opportunity to directly influence the customer. This electronic media system and method is universal for all traders and customers irrespective of the type of their products and needs. It secures the delivery of the exact or a very close matching product ordered by the customer at a price closely monitored by all market participants. The present invention may comprise one or more of the features recited in the attached claims, and/or one or more of the following features and combinations thereof.

A described electronic media system and method provides the customer with the ability to send any merchandise request through a user-friendly interface. This is a much more efficient and fun way for a recipient to quickly and easily identify the parameters of the desired product, such as product model, year made, style, any additional options, color, material it is made of, size, etc. Other optional requests and information like delivery preferences, qualifications for incentives or rebates, financial background, and desired method of payment may also be provided. For purposes of this invention, interface is a system that controls the way information is shown to an electronic device user and the way the user is able to work with the electronic device. Such system is designed by means of any web application software and may vary in its appearance and parameters.

After specifics of the desired merchandise are entered by the customer and validated, it is submitted to the server. The server performs a search, using the supplied data from the customer, looking through online products' listings that match, or closely match the criteria supplied by the customer. The system may also import the search to outside vendors, to use their servers and databases looking for matches. Optionally, server may return the product's search results to the customer by electronic means, such as an email, text message or a pop-up message on the original interface, instructing the customer to confirm the selection of discovered products or their close matches. After customer selects the desired products, the server performs the search of all available products' sellers. After sellers are identified, server notifies them of the customer's selected products by any preferred electronic means, like an email, text message or a pop-up message. The sellers are informed about the number and specifics of products selected by the customer, not disclosing the customer's identity, and omitting the details of the seller's competitors, or competitor's products. For a specified period of time, sellers will be given an opportunity to place ever decreasing bids on their own products attempting to garner the greatest interest in their product by the customer. The bidding process will be partially of fully visible to all competitors, enticing them to outbid each other. At the end of this reverse bidding time period, the lowest bidder is notified that they won the auction, while the customer is notified of the bidding process results. The seller is prompted to confirm the product availability. Upon confirmation, the server establishes communication between the seller and the customer, providing guidance on scheduling of the initial meeting to finalize the sale of the product. The system is designed to drive the price of the merchandise down to a minimum price available on the market without the customer's participation in the negotiation process.

Such electronic media system and method stimulates merchants to strip down all “hidden” costs usually associated with the merchandise. For instance, in car sales various hidden costs are part of a normal car buying routine. These could be fmance charges, vehicle registration fee, title fee, license fee, documentation fee, compliance fee, emissions testing fee, floor plan fee, advertising fee, dealer preparation fee, and various other “add-ons”, of which customer is not even aware. When buying the car at a dealership, negotiating with a sales person often leads to a stressful battle aimed at removing many unnecessary fees. The proposed electronic media system and method does it all for the customer, without him or her even being made aware of the process. By making all competitors cognizant of the pending deal, the system promotes integrity among the dealers. At the bidding step, merchants are still not provided with the potential customer's contact information, resulting in a stress-free car purchase experience.

After merchants place their bids into the system by simply responding to a notification, the client is asked to examine the entered bids and to make a next step selection. Since some of the merchandise could differ from the desired specification, customer may be provided with an opportunity to rank the choices one more time. If customer makes a final decision on a selected merchandise, the chosen item is placed in the system and the winning dealer gets notified that its product was selected. If customer provides a list of selected items, ranking their priority, all selected dealers may be asked again for their last chance to make a bid. This process may continue as many times as selected by customer, or as limited by the system. The final decision puts an end to the dealers' bidding, notifying the one with a winning bid. At this point, the dealer is placed in direct contact with the customer, allowing both parties to finalize the transaction in terms of payment and delivery options. Customer may be given a time-limit within which the transaction should be completed.

Dealers and Merchants are accustomed to write off a large percentage of their potential customers who simply stop by their store or browse through their website. Many potential customers will take numerous hours from sales personnel, just asking questions about a product only to purchase it later from a competitor. Dealership stores and websites compete for the customers' traffic, reaching only small numbers due to the high levels of competition. Traders will find that the proposed electronic media trading system and method provides a new and enormous benefit allowing them to reach even those customers that do not have time to stop by their store or visit their website. The system and method is designed to reach every seller available.

One of the embodiments of the proposed electronic media system and method is designed for the car-selling application. For purposes of this invention, a car refers to any motorized vehicle, including but not limited to the following: automobile, bus, van, pickup, SUV, small car, sport car, alternative power vehicle, construction vehicle, military vehicle, sport wagon, motorcycle.

The customer will use any input and output device to communicate with the system. Such device may be selected from, but not limited to, the following: desktop computer, laptop, notebook, iPad, iPod, smart phone, electronic handheld device, gaming console, tablet. The input and output device should be electronically connected to the server. For purposes of this invention, electronically connected could mean wired or wireless connection, allowing for the transition of the electronic or electromagnetic signal between the input and output device and the server.

The introductory screen of the system will allow the customer to enter the specifics of the desired vehicle, including, but not limited to, the make, model, and year of production, selecting “New” versus “Used”, and entering the zip code of the customer's residence. Such information narrows down the ensuing database search. Optionally, the following screen may focus the search even further by allowing the customer to select the vehicle trim package; exterior and interior color; and additional options like sound system, floor mats, bed liner, sun roof, leather, etc. Subsequently, the system would sum up the customer's selection on a summary screen, providing a Manufacturer's Suggested Retail Price, or MSRP, the price which the manufacturer recommends that the retailer sell the product. The intention of providing the MSRP is to help standardizing prices among locations. While some stores always sell at, or below, the MSRP, others do so only when items are on sale or closeout/clearance.

Optionally, the car-selling system may inquire on the customer's preference of the delivery versus picking the vehicle up at the store. The car-selling system may be equipped with tools to collect the customer's credit information. For instance, the system may request preferred method of payment, personal credit score information, ability to place the down payment, preferred lease term, and preferred finance term. The system may also be equipped to collect the customer's qualification for possible incentives and discounts.

The car-selling system may be equipped with the interface to collect the trade-in information. Trading the old vehicle in while purchasing the new one is widely used in the car-selling industry. The system will be able to collect the data on the vehicle offered for trade-in by the customer, including but not limited to the make, model, year of production, mileage, trim, condition of the vehicle, and the Vehicle Identification Number (VIN).

Optionally, the car-selling system may be equipped with the fee collecting option, allowing the system manager to accept a down payment on the transaction, or the full payment at the end of the transaction. When all information is entered by the customer and the search is triggered, the system selects best matches from the database stored on the system's server or from databases of the outside vendors. After the initial search is complete, the car-selling system notifies the customer about all selected vehicles, requesting the customer to pick the cars that they are interested in. For purposes of easy use, the car selection interface may be equipped with simple selection buttons. Upon completion of the selection, the car-selling system may trigger the bidding process. The car-selling system will procure bidding by sellers without involving the customer.

At the point of the negotiation ensuing, the car-selling system “knows” which dealers have cars that the customer is interested in. At that point of the process the customer does not “know” the dealer, and the dealer does not “know” the customer. The car-selling system generates a notification to each of the dealers that have cars that the buyer is interested in, including a link to a page on the dealer's website. At this point all dealers become aware of the rivalry with other dealers, and can see all cars on the customer selection list (competitors' details may be masked, and some details of the ongoing offer may be omitted, to prevent dealers from knowing the competition and colluding). The car-selling system invites dealers to start their bidding for the interested customer, by suggesting different prices than the ones initially placed on their website. The system may limit the time for dealers to enter their bids by installing a specific deadline, applying additional pressure on dealers. Every time the bid is placed, all participating dealers may be made aware of its placement. By the end of the deadline, the list of the customer-selected cars gets updated with new prices entered by participating dealers. The car-selling system may be equipped with an automated email/Short Message Service (SMS)/any other updater to dealers if new bids are not entered within the specified time period.

At the end of the bidding process, the car-selling system notifies the customer with the updated list of selected vehicles, stating the number of new offers on selected vehicles, and optionally triggering the time frame for the customer to accept one of the offers by installing the deadline for acceptance. If customer does not accept within the suggested time frame, the order gets cancelled, the participating dealers get notified, the customer exits the process, and the customer receives a notification that their request was cancelled and offers are no longer available.

If customer accepts an offer generated by the car-selling system, a notification is sent to dealers that were not selected, optionally informing them of the vehicle and the price that was selected by the customer. Simultaneously, the car-selling system generates a notification to a winning dealer, prompting them to enter the confirmation page of the car-selling system, validating the car availability and the dealer's ability to deliver the vehicle, and requesting the completion of the paperwork. Optionally, the car-selling system would prompt customer to finalize the services' payment. At the conclusion of the process, the notification is sent to the dealer, indicating that customer accepted the offer, including the time and date of the pick up or delivery.

The proposed electronic trading media system and method is not limited to car sales and could be used in sales of any merchandise that could be described by means of storing the image and/or specific description, such descriptions entered and itemized into an electronic database. The electronic media system and method performs by manipulating the stored data into searchable items. By means of using the electronic devise, such as computer, smart phone, tablet, game console, the electronic media system and method allows the customer to search for the desired item, initiating the bidding process among the traders in order to deliver the best result in terms of the specific match and the price.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a flow-through diagram depicting the system's search, reverse bidding process, and final sale.

FIG. 2. is a diagram depicting the channels of interaction between the customer, server of the electronic trading media system and method of sales (“system”), and suppliers.

FIG. 3 is a depiction of the car sales embodiment of the system's landing page for collecting the car's basic specifics.

FIG. 4 is a depiction of the car sales embodiment of the system's vehicle images webpage for the selection of the desired car's appearance.

FIG. 5 is a depiction of the car sales embodiment of the system's webpage for the selection of trim and style.

FIG. 6 is a depiction of the car sales embodiment of the system's webpage for the selection of exterior and interior color of the car.

FIG. 7 is a depiction of the car sales embodiment of the system's webpage for the selection of additional features and options of the car.

FIG. 8 is a depiction of the car sales embodiment of the system's webpage providing car summary and MSRP.

FIG. 9 is a depiction of the car sales embodiment of the system's webpage inquiring on the customer's delivery preferences.

FIG. 10 is a depiction of the car sales embodiment of the system's webpage for collection of method of payment and term information.

FIG. 11 is a depiction of the car sales embodiment of the system's webpage for collecting incentives information.

FIG. 12 is a depiction of the car sales embodiment of the system's webpage for collecting the trade-in information.

FIG. 13 is a depiction of the car sales embodiment of the system's webpage confirming the details of the requested car.

FIG. 14 is a depiction of the car sales embodiment of the system's payment webpage collecting the payment information.

FIG. 15 is a depiction of the car sales embodiment of the system's “Customer's Dashboard” webpage, providing a summary of the customer's selection.

FIG. 16 is a depiction of the car sales embodiment of the system's description of the process of the car search and notification of the customer with the search results.

FIG. 17 is a depiction of the car sales embodiment of the system's webpage prompting the customer to select the vehicles of interest.

FIG. 18 is a depiction of the car sales embodiment of the system's description of the process of the bidding initiation.

FIG. 19 is a depiction of the car sales embodiment of the system's webpage depicting the dealers' bidding process.

FIG. 20 is a depiction of the car sales embodiment of the system's description of the dealers' re-notification option.

FIG. 21 is a depiction of the car sales embodiment of the system's description of the bidding completion process.

FIG. 22 is a depiction of the car sales embodiment of the system's webpage prompting the customer for the offer acceptance.

FIG. 23 is a depiction of the car sales embodiment of the system's description of the notification process past the offer acceptance.

FIG. 24 is a depiction of the car sales embodiment of the system's webpage prompting the customer to finalize the deal.

FIG. 25 is a depiction of the car sales embodiment of the system's webpage for the collection of the final payment.

FIG. 26 is a depiction of the car sales embodiment of the system's description of the final instructions being sent through the system.

FIG. 27 is a depiction of the car sales embodiment of the system's description of the final invoice being sent through the system.

### DETAILED DESCRIPTION OF PREFERRED EMBODIMENTS

For the purposes of promoting and understanding the principles of the invention, reference will now be made to one or more illustrative embodiments illustrated in the drawings and specific language will be used to describe the same.

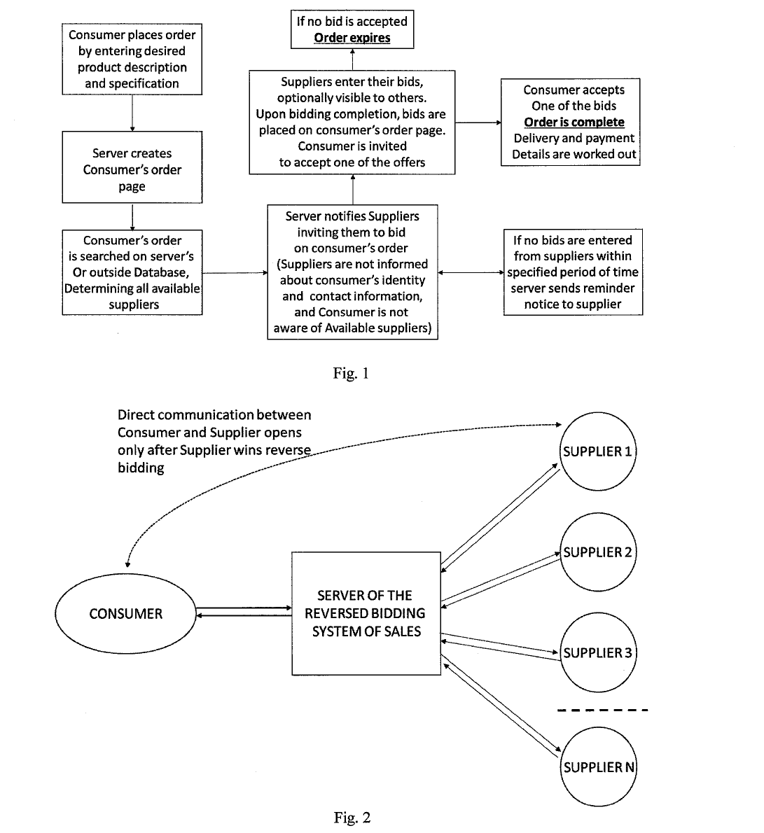

Referring to FIG. 1, an electronic media reverse bidding system is presented as a flow-scheme diagram, describing the process of placement of a specific order by the customer, followed by the creation of the Consumer's Order page. The server, or a multitude of outside servers, performs a search based on Consumer's Order, finding all available suppliers. Server notifies suppliers of the customer's interest in specific product, inviting each supplier to place a bid, offering an exact match or a close match to consumer's desired product. Suppliers enter their bids into the server, being notified about the time allotted for the bidding. Suppliers are optionally notified about the competing bids, with or without disclosing the identity of other suppliers, allowing to drive the price to a minimum, while preventing colluding. If no bids are entered by suppliers within a specified period of time, server sends additional notice to all suppliers, inviting them to place a bid. If no bid is presented, or if no offer is accepted, the offer expires. When bidding time expires, the bids become visible on the consumer's order page, inviting consumer to select one of the presented bids. If the bid is accepted, the communication opens between the customer and the winning supplier, driving the order to completion. Unlike majority of the existing sales methods, the present invention involves sellers in reverse bidding, sparing buyers from stress of the negotiation process and better price shopping.

FIG. 2 demonstrates a scheme, depicting the channels of interaction between consumer (“customer”, “buyer”), server, and multitude of suppliers (“dealer”, “trader”, “seller”). There is no direct interaction between the consumer and supplier, until the supplier wins the reverse bidding. Server, with the help of the operating system and software, manages the order acceptance and delivery of the order to prospective suppliers. Suppliers provide their bids back to the server. Server makes the bids visible to the buyer, prompting the buyer to select one of the bids. The channel of communication between the buyer and seller stays closed, until the winning bid is selected.

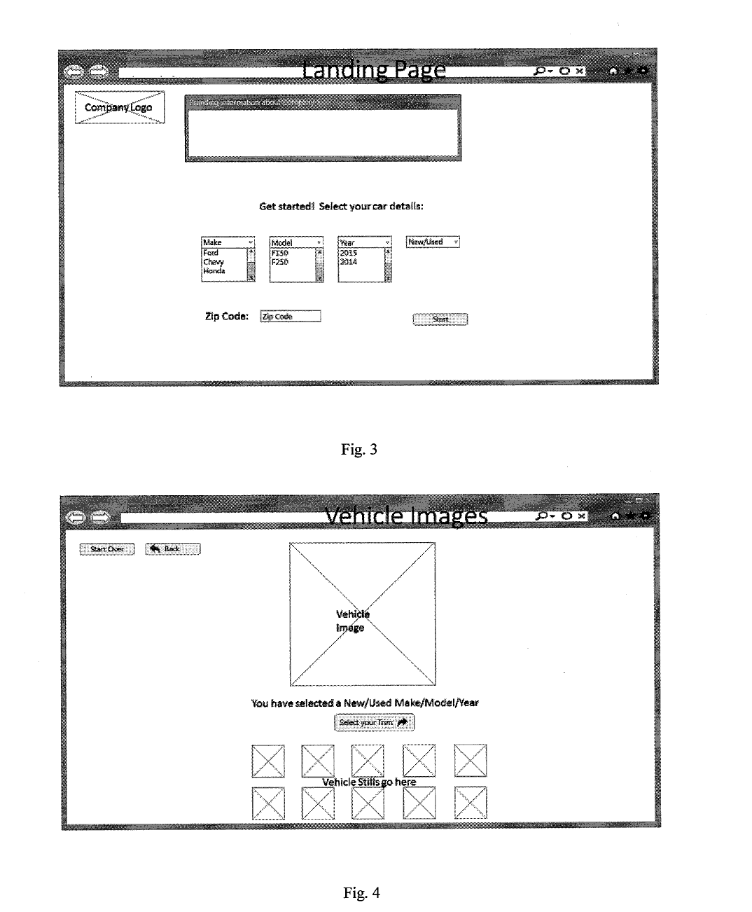

Referring to FIGS. 3 through 27, the car sales' embodiment of the invention is presented. Illustrations demonstrate the interface webpages and steps, being disclosed in a sequential manner allowing for a better understanding of the invention. The illustrations could be divided into the following steps: customer order placement (FIGS. 3-15); server's communication to available dealers and initiation of the reverse bidding process (FIGS. 16-23); opening of the communication between seller and dealer, and sale's completion (FIGS. 24-27)

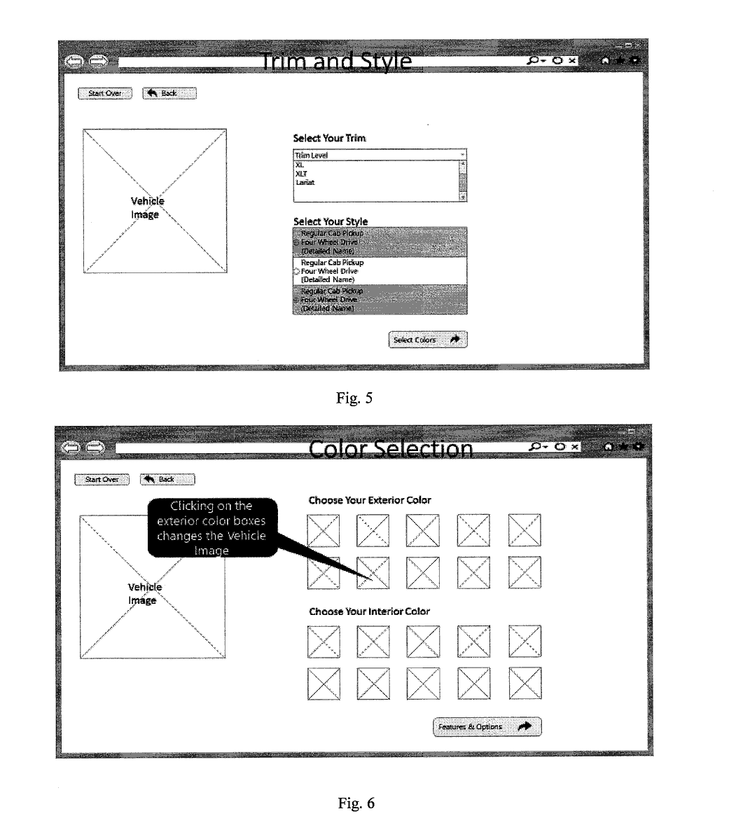

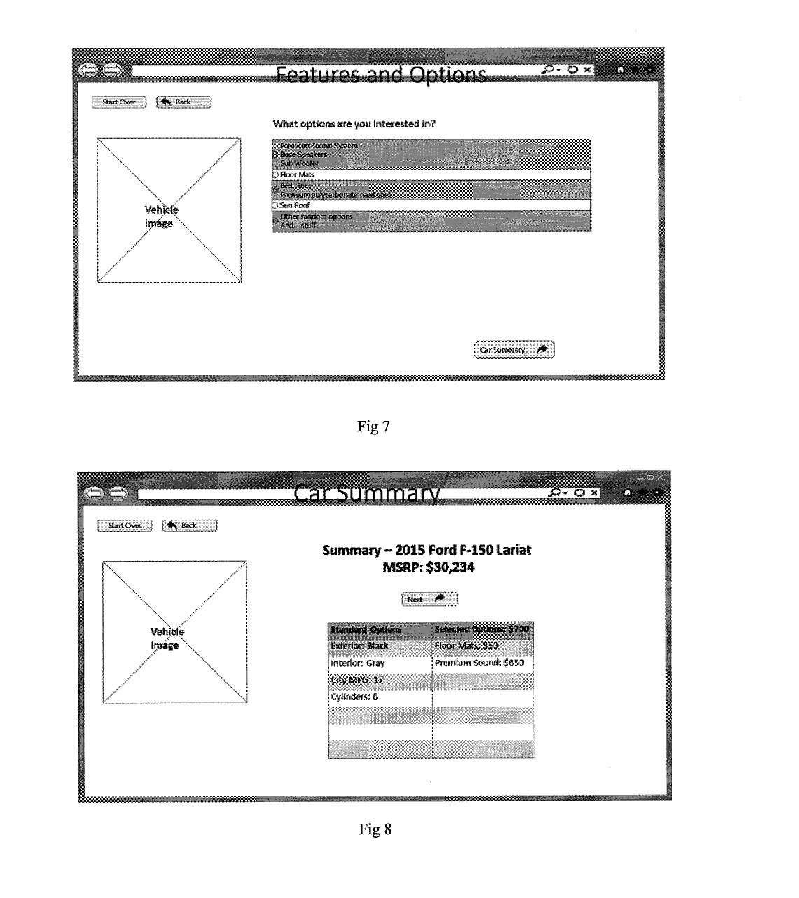

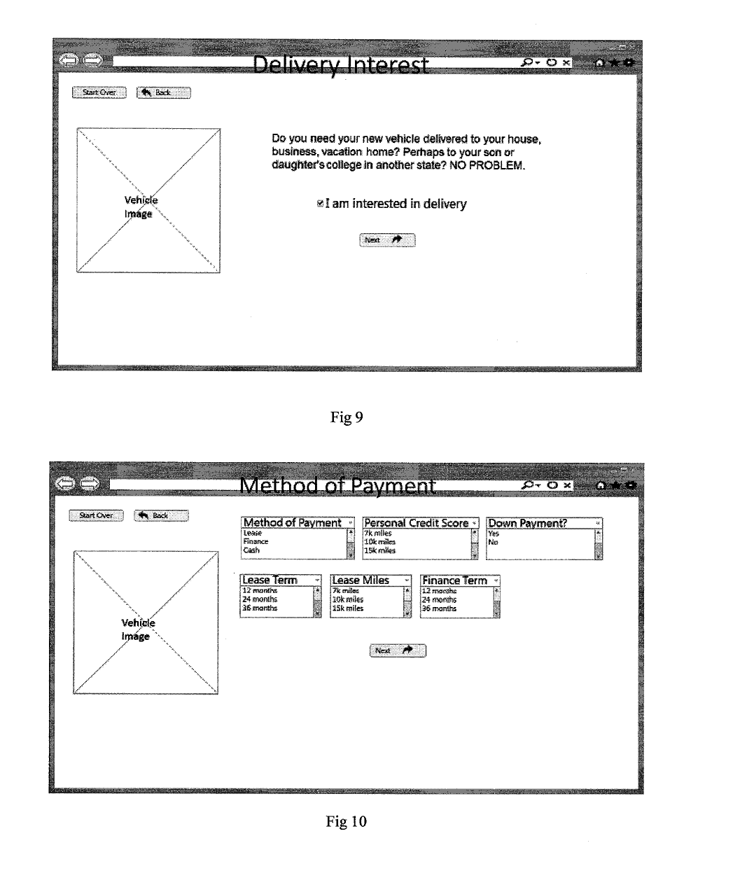

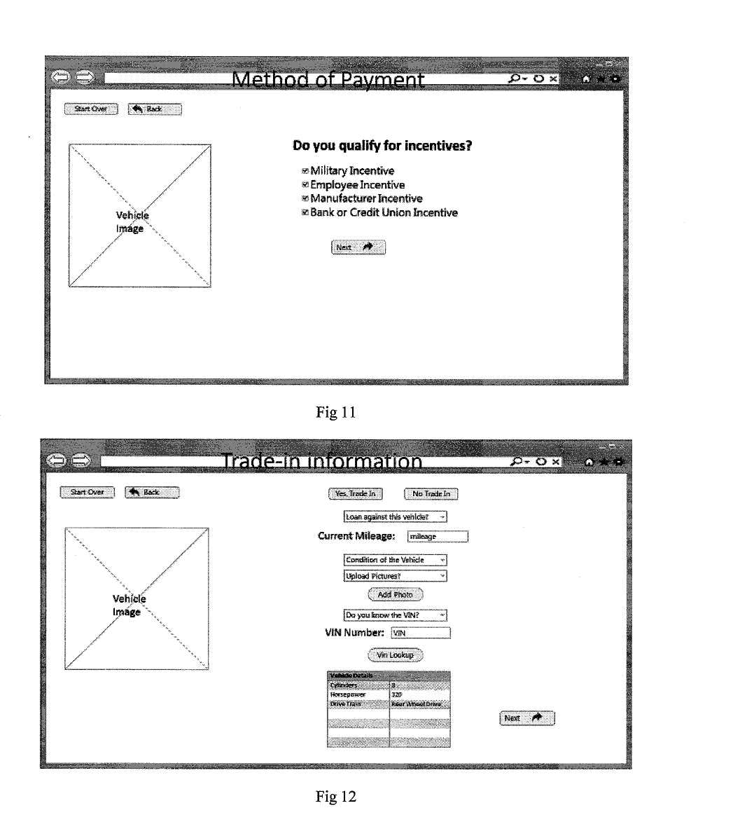

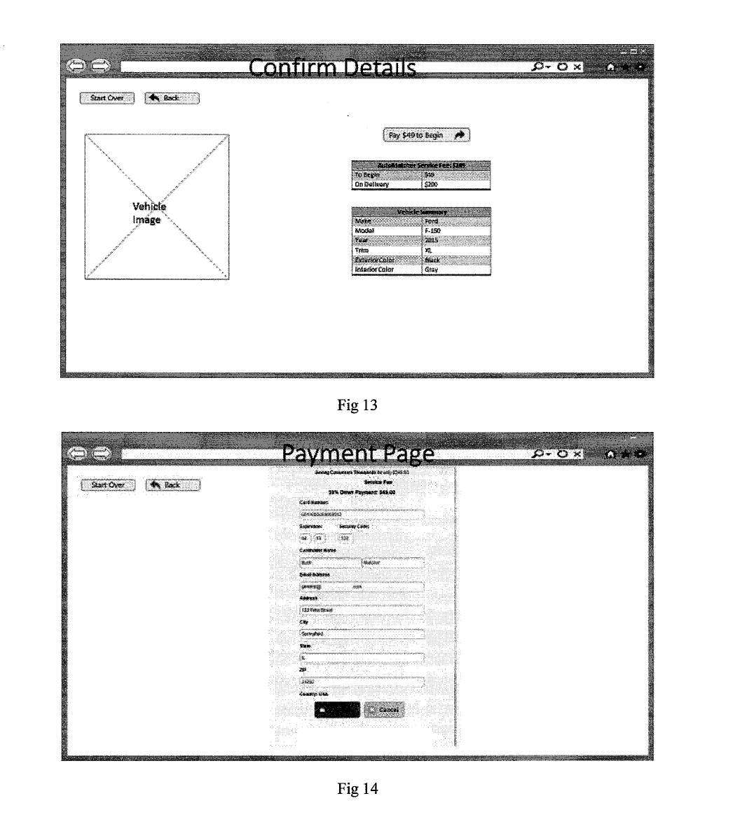

In the car sales' embodiment of the invention, the user interface leads the buyer to the introductory, or Landing page, prompting the buyer to enter the desired vehicle's specifications (FIG. 3). Such specifications may include make, model, and year of the vehicle. The buyer may also have an option to select between a new and used vehicle. On the same or the next page, the buyer could be asked to select from the list of available vehicle images (FIG. 4). Trim and style could be offered on a separate page (FIG. 5), as well as options for color selections (FIG. 6) and any additional features and options (FIG. 7). All selections could be summarized and placed on one page (FIG. 8). The buyer may also be given an option of the vehicle delivery, if pick up is difficult (FIG. 9). The method of payment screen prompts the buyer to select between purchasing the vehicle, or proceeding with the lease (FIG. 10). The buyer may also be asked to indicate the availability for any incentives (FIG. 11). As an additional option, system may inquire on the buyer's trade-in information (FIG. 12). Trade-ins are widely used in car sales, and attaching such option is beneficial for both the buyer and the seller. After confirming the vehicle selection and price options (FIG. 13), the buyer is prompted for the payment processing (FIG. 14).

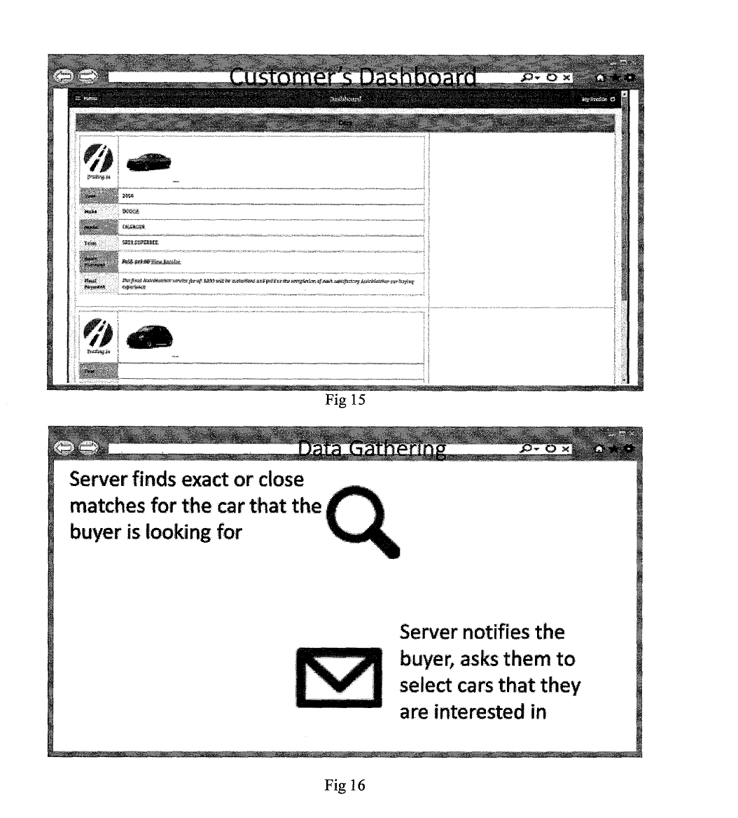

After the buyer completes all inquiries, the information is assembled on a Customer's Order page (shown as a Customer's Dashboard on FIG. 15). The buyer may have another chance to confirm all selections, before setting the server in a search mode.

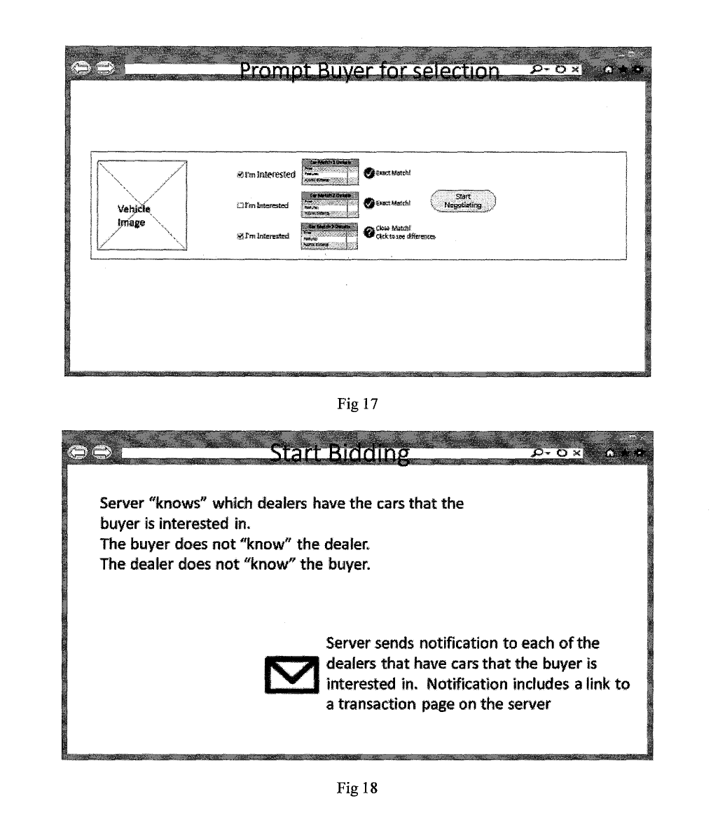

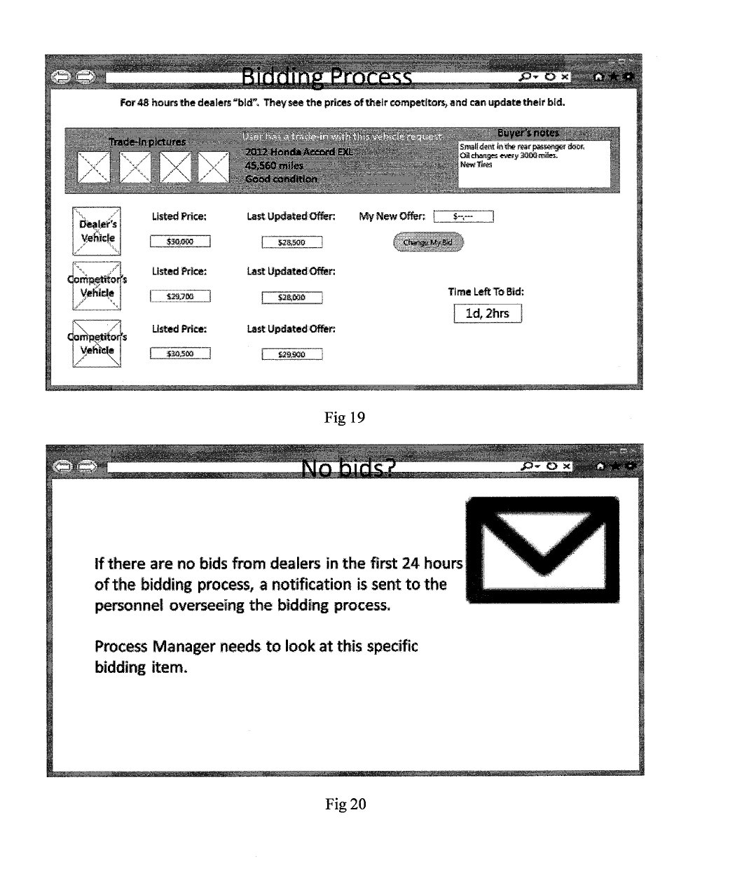

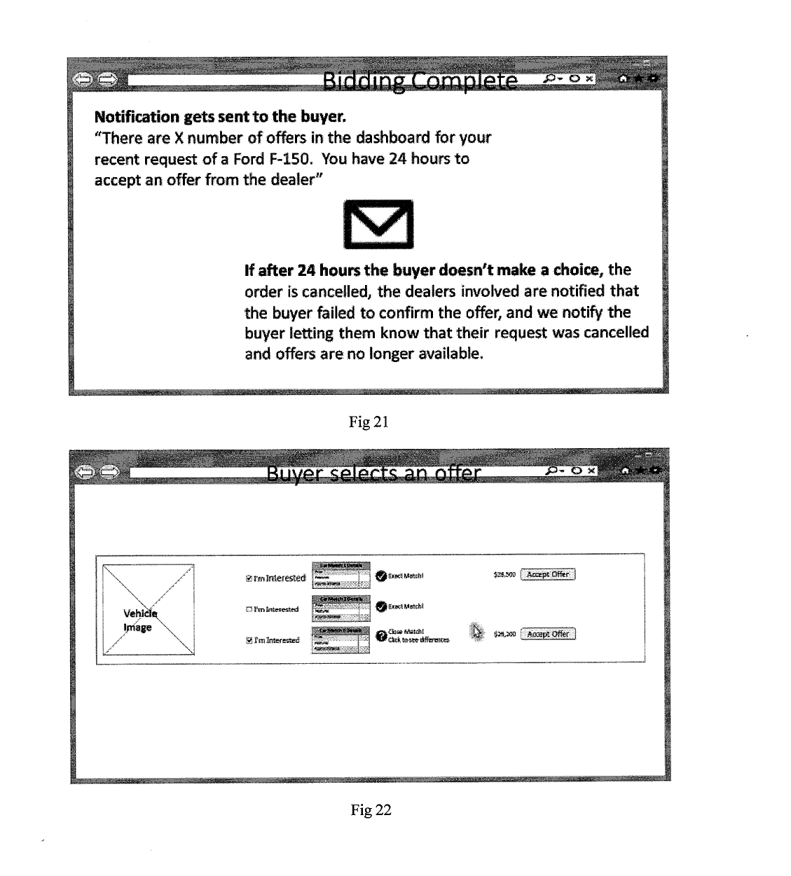

The server initiates the search, finding exact or close matches for the car that the buyer is looking for (FIG. 16). After the search is complete, the results are delivered to the buyer, prompting him or her to select any number of vehicles buyer may like (FIG. 17). Selection of vehicles of interest starts the process of negotiations, or reverse bidding (FIG. 18). At this point server sends notification to each of the dealers that have cars that the buyer is interested in. Notification includes a link to a transaction page on the server, informing each dealer about the deadline for the bids submission. During the bidding process (FIG. 19) each dealer is aware of the competitor, but not their identity. Each dealer has the opportunity to see competitor's vehicle image, its price, and optionally some specifications. Having such option assures decreasing bids by competitors (reverse bidding) in an attempt to gamer the greatest interest in their own vehicle by the buyer. The buyer and the seller are not introduced to each other at this point. If no bids are introduced, the server re-sends notifications to dealers during the bidding process time-frame (FIG. 20). Upon the bidding completion, server sends notification to the buyer informing the buyer on the number of offers, and asking the buyer to make a selection within certain time (FIG. 21). The order expires if the buyer fails to select the vehicle. Such options guarantee the timely process completion. The bidding process comes to an end as the buyer makes a final vehicle selection (FIG. 22).

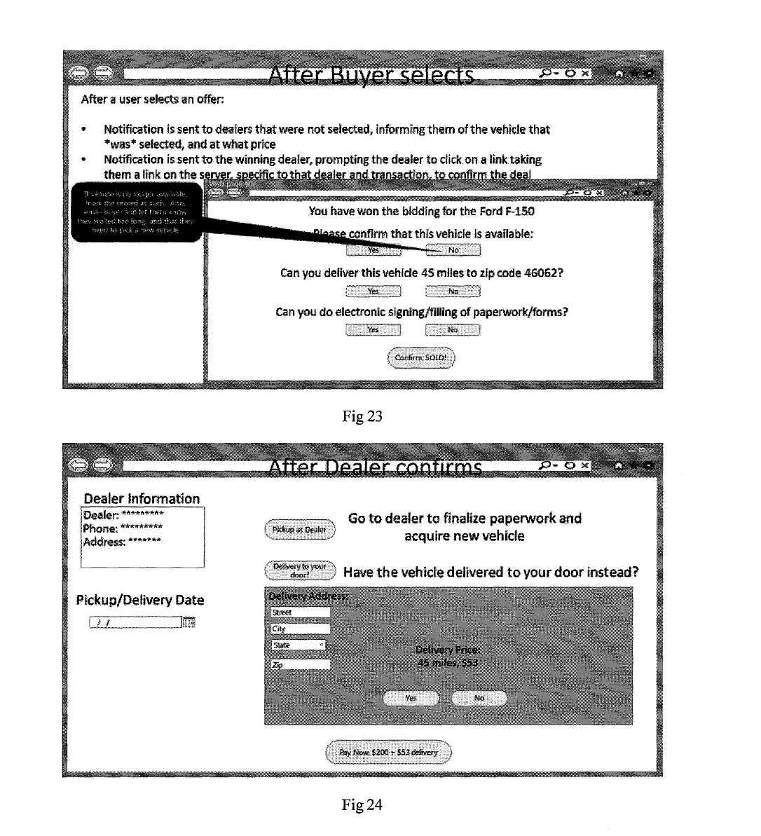

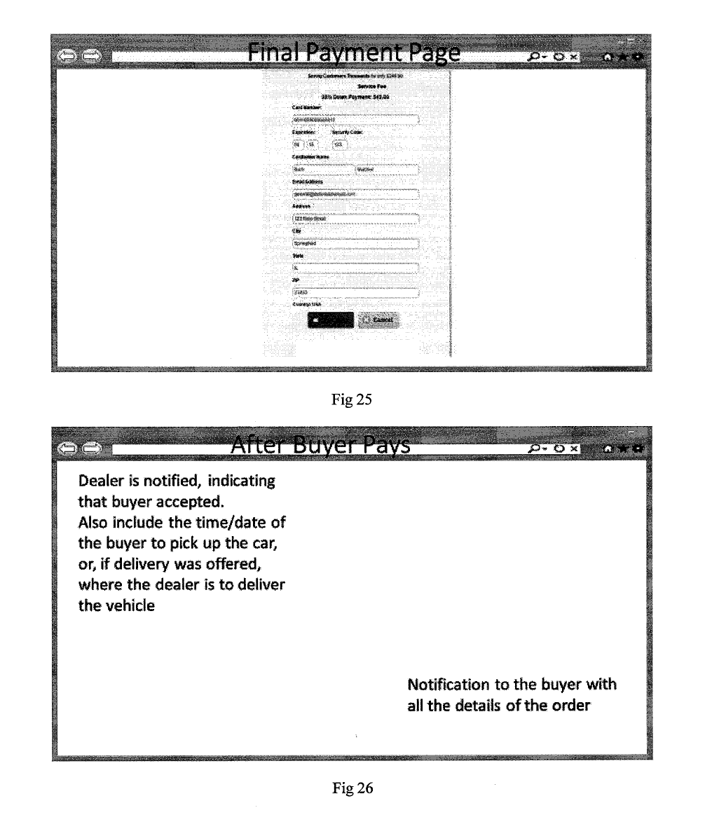

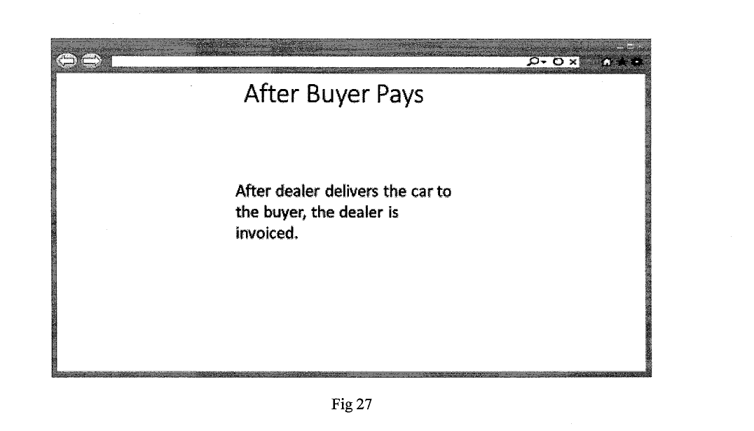

After the buyer makes the final vehicle selection, the server informs the winning bidder, inquiring on the vehicle availability, delivery options, and any other procedural questions to make a smooth and speedy transaction (FIG. 23). The seller confirms the availability and delivery options, indicating any additional pricing (FIG. 24). The payment processing page (FIG. 25) could be set as a trigger to connect the buyer and the seller (FIG. 26). At this point the direct channels of communication are opened between the customer and dealership, to finalize the pre-negotiated sale of the vehicle. The payment by the buyer and the vehicle delivery by the seller conclude the transaction (FIG. 27).

While the proposed system and method has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the following claims are desired to be protected.

1. An electronic media trading system for a product trade comprising:
a host server connected to an internet stored data containing at least product sellers' names, product inventories, product images, product prices, product sellers' contact and address information, said data comprising a search database;
a product information input and output device connected to the host server by means of an electronic connection, the product information input and output device allowing a buyer to enter a product information and to receive an information from the host server;
a computer-executable instructions directing the host server to perform a search of a seller of the product entered through the product information input and output device, deliver the entered product information to the seller, solicit the seller to place a bid, entice sellers to modify their bids, deliver all solicited bids back to the product information input and output device, prompt the buyer at the input and output device to select a best available bid, connect the buyer and the seller after the bid is selected.

2. The electronic media trading system for a product trade of claim 1, wherein said search database is stored on the host server.

3. The electronic media trading system for a product trade of claim 1, wherein sellers are made aware of other sellers' bids.

4. The electronic media trading system for a product trade of claim 1, wherein the buyer is requested to confirm a modified product selection prior to delivering the entered product information to the seller.

5. The electronic media trading system for a product trade of claim 1, wherein said input and output device comprises a processing unit interconnected with a memory for storing files, a display device and means to input information.

6. The electronic media trading system for a product trade of claim 1, wherein said input and output device comprises one of: desktop computer, laptop, notebook, iPad, iPod, smart phone, electronic handheld device, gaming console, tablet.

7. The electronic media trading system for a product trade of claim 1, wherein said product is a car.

8. The electronic media trading method comprising:
prompting a buyer to enter product information into a product information input and output device, connected by means of electronic connection to a host server, the product information comprising of a name, a type, a model, a description, a year of manufacture of a product, said host server connected to a search database;
searching for the entered product and prompting the buyer to confirm the product selection;
searching for the selected product sellers' electronic contact and address information through the search database;
delivering to all available sellers the entered product information and soliciting sellers to place a bid for the entered product;
collecting all bids during a specified period of time, allowing sellers to see other sellers' bids and to modify bids making them more attractive to the buyer;
delivering all final bids to the buyer into the product information input and output device;
prompting the buyer to select the winning bid;
notifying the seller of the winning bid and establishing direct connection between the seller and the buyer to finalize the purchase.

9. A method of claim 8, wherein said method is used for selling cars.
